(19) United States
(12) Patent Application Publication
(10) Pub. No.: US 2025/0083644 A1
(43) Pub. Date: Mar. 13, 2025

(54) SINGLE MOTOR SLIDING WIPER SYSTEM

(71) Applicant: GM Global Technology Operations LLC, Detroit, MI (US)

(72) Inventor: Gabriel Strong, Rochester Hills, MI (US)

(21) Appl. No.: 18/462,773

(22) Filed: Sep. 7, 2023

(51) Int. Cl. B60S 1/34; B60S 1/08

(52) U.S. Cl. CPC B60S 1/3404; B60S 1/08

(57) ABSTRACT

A wiper assembly for a vehicle window includes a rail configured to be fixed to a vehicle body. The rail includes a first rail portion extending in a first direction along a rail length and a second rail portion extending in a second direction different than the first direction along the rail length. A wiper is operably connected to the rail and is configured to be driven along the rail length through both the first rail portion and the second rail portion to remove water from a surface of the vehicle window.

### INTRODUCTION

The subject disclosure relates to vehicles, and in particular to wiper systems for vehicle windows.

Vehicles include wiper systems to remove water or the like from the surface of the window to improve visibility for the driver. Wiper systems for rear windows of vehicles such as vans, wagons, or sport utility vehicles typically include a single wiper arm located at or near a lateral center of the rear window. Such systems include a motor having a forward and reversing direction, driving a single dimension of motion, either rotation or translation. The typical rear window wiper system employs a rotary motion, and thus the portion of the rear window swept by the wiper blade is limited by the length of the wiper blade that may be utilized. In many rear windows, such as those with a relatively small vertical height relative to lateral width, such a limitation leaves a large portion of the rear window unswept by the wiper blade.

Accordingly, it is desirable to provide a wiper system that is configured to remove water from a larger portion of the rear window.

### SUMMARY

In one exemplary embodiment, a wiper assembly for a vehicle window includes a rail configured to be fixed to a vehicle body. The rail includes a first rail portion extending in a first direction along a rail length and a second rail portion extending in a second direction different than the first direction along the rail length. A wiper is operably connected to the rail and is configured to be driven along the rail length through both the first rail portion and the second rail portion to remove water from a surface of the vehicle window.

In addition to one or more of the features described herein, the wiper includes a motor operably connected to the rail to drive the wiper along the rail length and a wiper arm having a fixed position relative to the motor.

In addition to one or more of the features described herein, the motor is operably connected to the rail via one or more gears meshed with a complimentary drive feature of the rail.

In addition to one or more of the features described herein, one or more brackets at least partially surround the rail. The motor and the wiper arm are fixed to the one or more brackets.

In addition to one or more of the features described herein, a plurality of rollers extend from the one or more brackets toward the rail to guide the wiper along the rail length.

In addition to one or more of the features described herein, the plurality of rollers are urged into contact with the rail to maintain correct orientation of the wiper relative to the rail.

In addition to one or more of the features described herein, the motor drives the wiper along both the first rail portion and the second rail portion.

In addition to one or more of the features described herein, the motor is a reversing motor.

In addition to one or more of the features described herein, the second rail portion is positioned at an angle of 90 degrees relative to the first rail portion.

In another exemplary embodiment, a vehicle includes a vehicle body including one or more windows, and a wiper assembly positioned at a window of the one or more windows. The wiper assembly includes a rail fixed to the vehicle body. The rail includes a first rail portion extending in a first direction along a rail length, and a second rail portion extending in a second direction different than the first direction along the rail length. A wiper is operably connected to the rail and is configured to be driven along the rail length through both the first rail portion and the second rail portion to remove water from a surface of the window.

In addition to one or more of the features described herein, the wiper includes a motor operably connected to the rail to drive the wiper along the rail length, and a wiper arm having a fixed position relative to the motor.

In addition to one or more of the features described herein, the motor is operably connected to the rail via one or more gears meshed with a complimentary drive feature of the rail.

In addition to one or more of the features described herein, one or more brackets at least partially surround the rail, and the motor and the wiper arm are fixed to the one or more brackets.

In addition to one or more of the features described herein, a plurality of rollers extend from the one or more brackets toward the rail to guide the wiper along the rail length.

In addition to one or more of the features described herein, the plurality of rollers are urged into contact with the rail to maintain correct orientation of the wiper relative to the rail.

In addition to one or more of the features described herein, the motor drives the wiper along both the first rail portion and the second rail portion.

In addition to one or more of the features described herein, the first rail portion is located vertically above the window.

In addition to one or more of the features described herein, the window is a rear window of the vehicle.

In yet another exemplary embodiment, a method of operating a wiper of a vehicle window includes securing a rail to a vehicle body at a window of the vehicle. The rail includes a first rail portion extending in a first direction along a rail length, and a second rail portion extending in a second direction different than the first direction along the rail length. A wiper operably connected to the rail is driven along the rail length through both the first rail portion and the second rail portion to remove water from a surface of the vehicle window.

In addition to one or more of the features described herein, when operation of the wiper is stopped, the wiper is returned to the second rail portion.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of an embodiment of a vehicle;

FIG. 2 is an illustration of an embodiment of a wiper in a first position at a vehicle window;

FIG. 3 is an illustration of an embodiment of a wiper in a second position at a vehicle window;

FIG. 4. is a partial view of an embodiment of a wiper arm mounted on a rail; and

FIG. 5 is a cross-sectional view of the embodiment of FIG. 4 along line 5-5.

### DETAILED DESCRIPTION

The following description is merely exemplary in nature and is not intended to limit the present disclosure, its application or uses. It should be understood that throughout the drawings, corresponding reference numerals indicate like or corresponding parts and features.

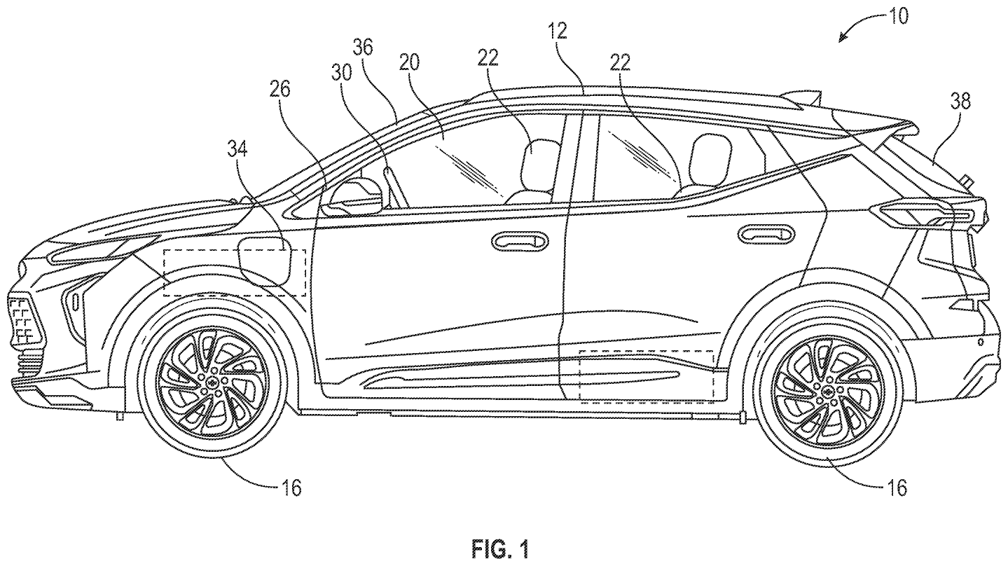

In accordance with an exemplary embodiment a vehicle is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes a propulsion system 34 to provide power to one or more of the plurality of wheels 16. The vehicle 10 further includes a windshield 36 at a forward end of the passenger compartment 20, and a rear window 38 at a rearward end of the passenger compartment 20.

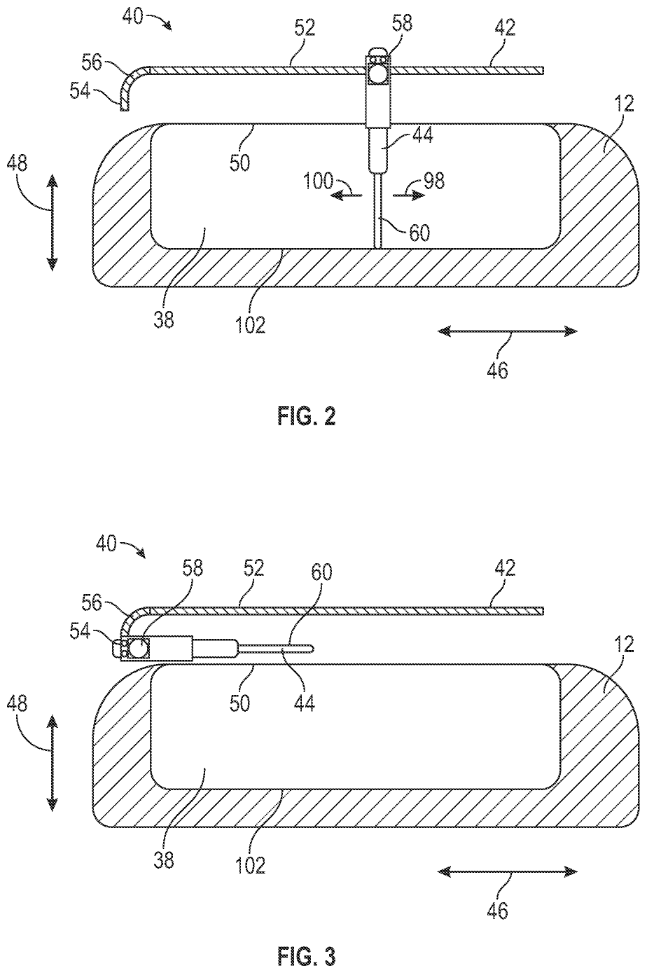

Referring now to FIG. 2, a wiper assembly 40 is located at the rear window 38 and is configured to selectably remove water or other material from an outer surface of the rear window 38. While this disclosure is presented in the context of a wiper assembly 40 for a rear window 38, one skilled in the art will readily appreciate that the present disclosure may be readily adapted for use with a windshield 36 or other vehicle window. The wiper assembly 40 includes a wiper arm 44 mounted on a rail 42 extending across the rear window 38, with the wiper arm 44 operably connected to and movable along the rail 42. In some embodiments, such as illustrated in FIG. 2, the rail 42 extends two dimensionally relative to the rear window 38, such as at least partially along a lateral window width 46 direction and at least partially along a vertical window height 48 direction. In the embodiment illustrated, the rail 42 is located vertically above an upper window edge 50 of the rear window 38, but this position is merely exemplary, and in other embodiments the rail 42 may be located vertically below a lower window edge 102, opposite the upper window edge 50. Along a rail length, the rail 42 includes a travel portion 52 and a parking portion 54. The rail 42 changes orientation between the travel portion 52 and the parking portion 54 via, for example, a transition portion 56 that may be an arc, which in some embodiments extends through about 90 degrees. As illustrated in FIGS. 2 and 3, the wiper arm 44 is configured to travel along the travel portion 52 in two opposing directions to remove water from the rear window 38, and is configured to move along the rail 42, through the transition portion 56 and to the parking portion 54 when wiping operations are stopped. This operation defines the two-dimensional motion of the wiper arm 44.

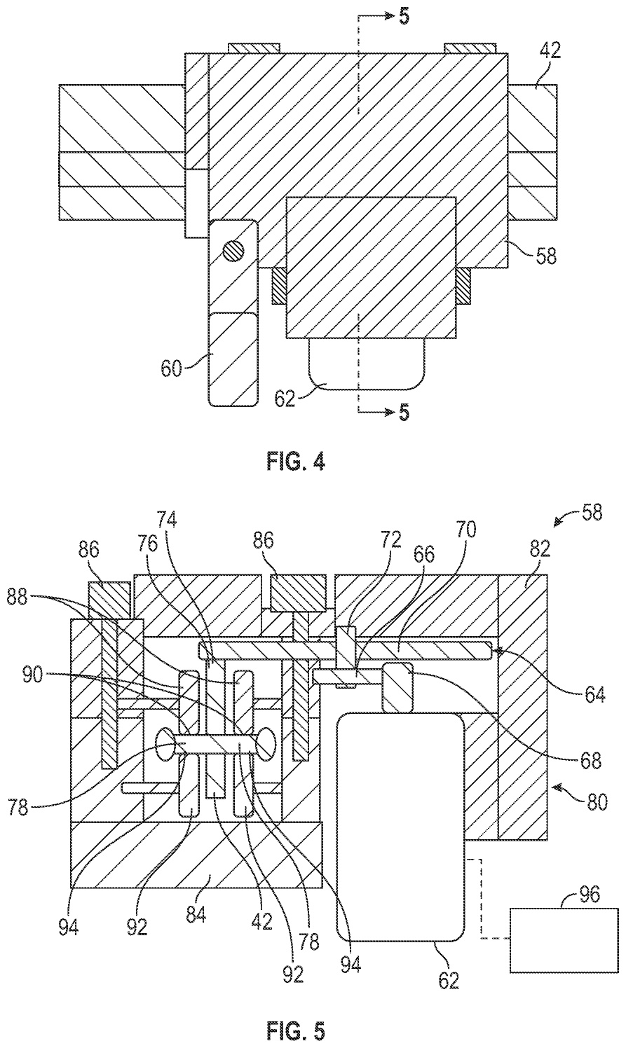

The wiper arm 44 includes an arm base 58 at which the wiper arm 44 is operably connected to the rail 42, and a wiper blade 60 which is interactive with the rear window 38 to remove water therefrom during operation of the wiper assembly 40. Referring now to FIGS. 4 and 5, the arm base 58 includes a bi-directional motor 62 which is connected to the rail 42 via a gear arrangement 64. The gear arrangement 64 includes a first gear 66 meshed with an output shaft 68 of the motor 62, and a second gear 70 located on a common gear shaft 72 with the first gear 66 and meshed to a complimentary drive feature 74 of the rail 42. Rotation of the second gear 70 driven by the gear shaft 72 moves the wiper arm 44 along the rail 42, via the engagement of the second gear 70 with the drive feature 74.

As best shown in the cross-sectional view of FIG. 5, the rail 42 includes a rail body 76 including the drive feature 74 and two rail arms 78 extending outwardly from the rail body 76 in opposite directions. In some embodiments, the two rail arms 78 extend perpendicularly from the rail body 76. The motor 62 is secured in a housing 80 which at least partially surrounds the rail 42. In some embodiments, the housing 80 includes a first bracket 82 and a second bracket 84 located at opposing sides of the rail 42. The first bracket 82 is secured to the second bracket 84 by one or more fasteners 86, such as bolts, screws or the like, thus surrounding the rail 42 as shown in FIG. 5. First rollers 88 are secured to the first bracket 82 and are disposed at a first arm side 90 of each of the rail arms 78, and similarly second rollers 92 are secured to the second bracket 84 and are disposed at a second arm side 94 of each of the rail arms 78, opposite the first arm side 90. When the first bracket 82 is secured to the second bracket 84, a clamping force is exerted such that the first rollers 88 are urged into contact with the first arm side 90 and the second rollers 92 are urged into contact with the second arm side 94, thus restricting movement of the wiper arm 44 to the direction along the rail 42 length and to keep the wiper arm 44 properly aligned to the rail 42.

The motor 62 is connected to a controller 96 that controls operation of the wiper assembly 40 via interaction with an operator of the vehicle 10 and/or sensors such as rain sensors. When not in operation, the wiper arm 44 is positioned in the park location, as illustrated in FIG. 3. Upon receiving a wipe command from the controller 96, the wiper arm 44 moves from the park location along the travel portion 52 to remove water from the rear window 38. As illustrated in FIG. 2, the motor 62 drives the wiper arm 44 in a first direction 98 along the travel portion 52, then reverses to travel in a second direction 100 along the travel portion 52. In continued operation, the motor 62 will continue to reverse when the wiper arm 44 reaches each end of the travel portion 52 to continue wiping operation. When a stop or park command is received by the motor 62 from the controller 96, the wiper arm 44 is driven in the second direction 100 through the transition portion 56 and into the parking portion 54 to the park location, as illustrated in FIG. 3.

The wiper assembly 40 configurations disclosed herein results in a larger wiper pattern relative to a conventional rotating wiper, while maintaining the relatively low cost and power draw of a convention rotating wiper via the use of a single motor 62 for operation of the wiper assembly 40. improve the wiper pattern.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A wiper assembly for a vehicle window, comprising:
a rail configured to be fixed to a vehicle body, the rail including:
a first rail portion extending in a first direction along a rail length; and
a second rail portion extending in a second direction different than the first direction along the rail length; and
a wiper operably connected to the rail and configured to be driven along the rail length through both the first rail portion and the second rail portion to remove water from a surface of the vehicle window;
wherein the wiper includes:
a motor operably connected to the rail to drive the wiper along the rail length; and
a wiper arm having a fixed position relative to the motor;
wherein two brackets at least partially surround the rail, the motor and the wiper arm fixed to the brackets;
wherein a plurality of rollers extend from the brackets toward the rail to guide the wiper along the rail length, each bracket of the two brackets having a roller of the plurality of rollers affixed thereto;
wherein the plurality of rollers are urged into contact with the rail via a clamping force securing a first bracket of the two brackets to a second bracket of the two brackets to maintain correct orientation of the wiper relative to the rail;
wherein the clamping force is applied via one or more fasteners securing the first bracket to the second bracket.

2. (canceled)

3. The wiper assembly of claim 1, wherein the motor is operably connected to the rail via one or more gears meshed with a complimentary drive feature of the rail.

4. (canceled)

5. (canceled)

6. (canceled)

7. The wiper assembly of claim 1, wherein the motor drives the wiper along both the first rail portion and the second rail portion.

8. The wiper assembly of claim 1, wherein the motor is a reversing motor.

9. The wiper assembly of claim 1, wherein the second rail portion is positioned at an angle of 90 degrees relative to the first rail portion.

10. A vehicle, comprising:
a vehicle body, the vehicle body including a window; and
a wiper assembly disposed at the window, including:
a rail fixed to the vehicle body, the rail including:
a first rail portion extending in a first direction along a rail length; and
a second rail portion extending in a second direction different than the first direction along the rail length; and
a wiper operably connected to the rail and configured to be driven along the rail length through both the first rail portion and the second rail portion to remove water from a surface of the window;
wherein the wiper includes:
a motor operably connected to the rail to drive the wiper along the rail length; and
a wiper arm having a fixed position relative to the motor;
wherein two brackets at least partially surround the rail, the motor and the wiper arm fixed to the brackets;
wherein a plurality of rollers extend from the brackets toward the rail to guide the wiper along the rail length, each bracket of the two brackets having a roller of the plurality of rollers affixed thereto;
wherein the plurality of rollers are urged into contact with the rail via a clamping force securing a first bracket of the two brackets to a second bracket of the two brackets to maintain correct orientation of the wiper relative to the rail;
wherein the clamping force is applied via one or more fasteners securing the first bracket to the second bracket.

11. (canceled)

12. The vehicle of claim 10, wherein the motor is operably connected to the rail via one or more gears meshed with a complimentary drive feature of the rail.

13. (canceled)

14. (canceled)

15. (canceled)

16. The vehicle of claim 10, wherein the motor drives the wiper along both the first rail portion and the second rail portion.

17. The vehicle of claim 10, wherein the first rail portion is disposed vertically above the window.

18. The vehicle of claim 10, wherein the window is a rear window of the vehicle.

19. A method of operating a wiper of a vehicle window, comprising:
securing a rail to a vehicle body at a window of the vehicle, the rail including:
a first rail portion extending in a first direction along a rail length; and
a second rail portion extending in a second direction different than the first direction along the rail length; and
driving a wiper operably connected to the rail along the rail length through both the first rail portion and the second rail portion to remove water from a surface of the window;
wherein the wiper includes:
a motor operably connected to the rail to drive the wiper along the rail length; and
a wiper arm having a fixed position relative to the motor;
wherein two brackets at least partially surround the rail, the motor and the wiper arm fixed to the brackets;
wherein a plurality of rollers extend from the brackets toward the rail to guide the wiper along the rail length, each bracket of the two brackets having a roller of the plurality of rollers affixed thereto;
wherein the plurality of rollers are urged into contact with the rail via a clamping force securing a first bracket of the two brackets to a second bracket of the two brackets to maintain correct orientation of the wiper relative to the rail;
wherein the clamping force is applied via one or more fasteners securing the first bracket to the second bracket.

20. The method of claim 19, further comprising when operation of the wiper is stopped, the wiper is returned to the second rail portion.

21. The wiper assembly of claim 1, wherein the rail includes a transition portion connecting the first rail portion to the second rail portion.

22. The wiper assembly of claim 21, wherein the transition portion is an arc.

23. The wiper assembly of claim 22, wherein the arc extends through 90 degrees.

24. The wiper assembly of claim 1, wherein the rail is configured to extend at least partially along a window width and at least partially along a window height.

25. The vehicle of claim 10, wherein the rail includes a transition portion connecting the first rail portion to the second rail portion.

26. The vehicle of claim 25, wherein the transition portion is an arc.

27. The vehicle of claim 26, wherein the arc extends through 90 degrees.

28. The vehicle of claim 10, wherein the rail is configured to extend at least partially along a window width and at least partially along a window
